(19) United States
(12) Patent Application Publication
(10) Pub. No.: US 2021/0195020 A1
(43) Pub. Date: Jun. 24, 2021

(54) COMMUNICATION SYSTEM AND METHOD

(71) Applicant: Blinder Limited, Auckland Central, Auckland (NZ)

(72) Inventors: Caley WILSON, Three Kings, Auckland (NZ); Ross Gordon MCCONNELL, Mellons Bay, Auckland (NZ)

(73) Assignee: Blinder Limited, Auckland Central, Auckland (NZ)

(21) Appl. No.: 16/757,315

(22) PCT Filed: Oct. 19, 2018
(86) PCT No.: PCT/NZ2018/050146

§ 371 Date: Apr. 17, 2020

(30) Foreign Application Priority Data
Oct. 20, 2017 (NZ) 736391

(51) Int. Cl. H04M 3/432; H04M 3/42; H04M 3/51

(52) U.S. Cl. CPC H04M 3/432; H04M 3/5108; H04M 3/42093; H04M 3/42042

(57) ABSTRACT

A method of establishing a communication session between at least two parties is described the method comprising the steps of: receiving information from a plurality of parties, the information on the parties comprising: the party type selected for the group comprising targets, authorisers and requestors, and at least one communication method; receiving a request to store information on an authoriser; receiving a request from a requesting party to contact a target party; facilitating an agreement between the requesting party and the authoriser; receiving a schedule for at least one time period that the requesting party is authorised to contact the target party from the authoriser; notifying the requesting party of the at least one time period; and establishing a communication session between the requesting party and the target party if the requesting party is authorised to contact the target party at the time the communication session is initiated.

### FIELD

This invention relates to communication system and method

### BACKGROUND

High profile individuals do not want to provide their communication details to be known by a potential caller. This problem can particularly acute for individuals who come under intense scrutiny from news media and other members of the public, and hence may wish the details of their communication channels to remain anonymous.

It is an object of the invention to provide a communication system and method or to at least provide the public or industry with a useful choice.

### SUMMARY

According to one example embodiment there is provided a method of establishing a communication session between at least two parties comprising the steps of:
receiving information from a plurality of parties, the information on the parties comprising:
at least one associated party type, the party type selected for the group comprising targets, authorisers and requestors, and
at least one communication method;
storing the information;
receiving a request to store information on an authoriser, the information on the authoriser including:
information on the contacts with a target party the authoriser may authorise,
information on whether the authoriser may authorise other parties as authorisers, and
the period the authoriser is authorised for;
storing the information on the authoriser;
receiving a request from a requesting party to contact a target party;
communicating the request to contact a target party to an authoriser associated with the target party;
facilitating an agreement between the requesting party and the authoriser;
receiving a schedule for at least one time period that the requesting party is authorised to contact the target party from the authoriser;
notifying the requesting party of the at least one time period; and
establishing a communication session between the requesting party and the target party if the requesting party is authorised to contact the target party at the time the communication session is initiated.

Preferably the authorisers are authorised representatives of a target.

Preferably the authoriser and the target party are the same party.

Preferably including the step of receiving from each party information on a plurality of communication channels.

Preferably the communication channels are kept confidential and the step of establishing a communication session between the requesting party and the target party includes establishing a confidential communication session between the requesting party and the target party.

Preferably including the step of notifying the target party of the communication session including notifying the target party of the time period.

Preferably including the step of notifying the parties of the communication session.

Preferably including the step of providing a search tool to search the stored information on the parties and wherein the method incudes receiving a request to search for a target party and providing a list of target parties that match the search criteria.

Preferably including the step of receiving a request to exclude a target party for a search and wherein a target party that is excluded from a search is not provided in the list of target parties.

Preferably the communication session is established over a channel selected from the group comprising a web application, a mobile telephone, a telephone line

Preferably the steps of notifying the requesting party of the at least one time period occurs by connecting the requesting party.

Preferably establishing a communication session between the requesting party and the target party if the requesting party is authorised to contact the target party at the time the communication session is initiated occurs immediately.

Preferably the authoriser is a virtual authoriser.

Preferably the virtual authoriser accesses multiple data sources and applies machine learning to assist with connection and scheduling decisions.

Preferably the virtual authoriser uses neural networks to assist with connection and scheduling decisions.

Preferably one or more computer readable media storing computer-usable instructions that, when used by a computing device, causes the computing device to implement the method.

According to a further example embodiment there is provided a system for controlling communication session between at least two parties, the system comprising:
one or more processors;
memory in communication with the one or more processors;
a plurality of communication devices;

wherein the one or more processors are programmed to:
receive information from a plurality of parties, the information on the parties comprising:
   at least one associated party type, the party type selected for the group comprising targets, authorisers and requestors, and
   at least one communication method;
storing the information in memory;
receiving a request to store information on an authoriser, the information on the authoriser including:
   information on the contacts with a target party the authoriser may authorise,
   information on whether the authoriser may authorise other parties as authorisers, and
   the period the authoriser is authorised for;
storing the information on the authoriser in memory;
receiving a request from a requesting party to contact a target party;
communicating the request to contact a target party to an authoriser associated with the target party;
facilitating an agreement between the requesting party and the authoriser;
receiving a schedule for at least one time period that the requesting party is authorised to contact the target party from the authoriser;
notifying the requesting party of the at least one time period; and
establishing a communication session between the requesting party and the target party using the communication devices only if the requesting party is authorised to contact the target party at the time the communication session is initiated.

Preferably the authorisers are authorised representatives of a target party.

Preferably the authoriser and the target party are the same party.

Preferably the one or more processors are further programmed to receive from each party information on a plurality of communication channels.

Preferably the communication channels are kept confidential and establishing a communication session between the requesting party and the target party includes establishing a confidential communication session between the requesting party and the target party.

Preferably the one or more processors are further programmed to notify the target party of the communication session including notifying the target party of the time period.

Preferably the one or more processors are further programmed to notify the parties of the communication session.

Preferably the one or more processors are further programmed to provide a search tool to search the stored information on the parties and wherein the one or more processors are further programmed to receive a request to search for a target party and provide a list of target parties that match the search criteria.

Preferably the one or more processors are further programmed to receive a request to exclude a target party for a search and wherein a target party that is excluded from a search is not provided in the list of target parties.

Preferably the communication session is established over a channel selected from the group comprising a web application, a mobile telephone, a telephone line

Preferably the steps of notifying the requesting party of the at least one time period occurs by connecting the requesting party.

Preferably establishing a communication session between the requesting party and the target party if the requesting party is authorised to contact the target party at the time the communication session is initiated occurs immediately.

Preferably the authoriser is a virtual authoriser.

Preferably the virtual authoriser accesses multiple data sources and applies machine learning to assist with connection and scheduling decisions.

Preferably the virtual authoriser uses neural networks to assist with connection and scheduling decisions.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e., they will be taken to mean an inclusion of the listed components which the use directly references, and possibly also of other non-specified components or elements.

Reference to any document in this specification does not constitute an admission that it is prior art, validly combinable with other documents or that it forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention, in which:

FIG. 1 is a schematic of an exemplary embodiment of the invention;

FIG. 2A is a screen shot of an example user interface showing the communication session details;

FIG. 2B is a screen shot of an example user interface showing further communication session details;

FIG. 3 is a screen shot of an example user interface showing a summary of the communication session details;

FIG. 4 is a screen shot of two mobile phone screens showing a summary of the communication session details;

FIG. 5 is a flow diagram of the registration and communication flow of the system; and

FIG. 6 is a block diagram of a sample system controller;

### DESCRIPTION

The present application in one embodiment relates to a communication protocol that allows the user of a mobile device or other communication channel such as a web application or telephone line to schedule at least one communication session or telephone call to or from the communication channel without sharing the contact details for the communication session or native identification information.

The system provides a means for parties to negotiate and agree a specific time and duration, and optionally having a specific purpose. The system and method provides a software platform that can be used to register, negotiate, agree, schedule and route the call, and can be utilised with a broker, agent or authoriser acting as an intermediary or direct between individuals. The system and method is directed to situations where a requesting party knows the identity of the call target party but may not know their direct communication channel details, for example does not know their private mobile telephone number. The target party may be a VIP, and the requesting party may have a valid reason for requesting contact on a time limited basis, such as for a media interview. In a further example scenario, the target may authorize the authoriser to intercept incoming calls to their phone number (i.e. in the case where the requestor already has the targets contact information). The authoriser would then consider this initial call attempt as a request, and proceed to negotiate from there.

The system and method includes means for making requests to schedule a call with a target party, together with negotiation, agreement, scheduling and routing, while keeping contact details anonymous. The system and method provides for a traditional agent to act as a broker (or authorizer) for the communication session and allows negotiation, agreement and scheduling of calls.

In a further embodiment, the system and method provides a means to record the communication session and a means to enable the recorded session to be retrieved by the target party and with the authorisation of the target party the requesting party may also retrieve the recorded communication session.

In a further embodiment, the system and method provides a means to allow a target to share their direct communication channel details, for example their mobile telephone number and have an authoriser screen incoming calls and decide if the call should be connected 551 immediately, scheduled for a later date or ignored completely.

The system and method provides that an authorizer may authorise the communication session between a party requesting a communication session and a target party. In one embodiment, the target party may authorize the communication session or alternatively a party authorized by the target party may authorize the communication sessions

The system and method provides for unified communications such that one party may use an analogue telephone and another a messaging application. Communication between, analogue telephones, cellular telephone, voice over IP, internet messaging and video is provided for while allowing the parties to have anonymity.

A search engine is also provided that allows parties to find each other and initiate a call negotiation. Target parties may choose not to be searchable.

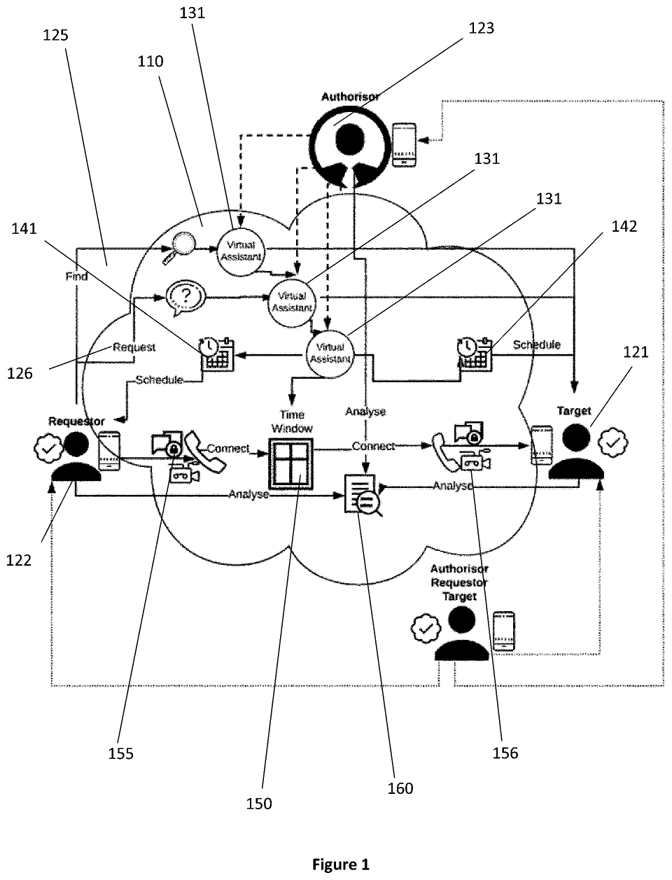

Referring to FIG. 1 an exemplary embodiment is illustrated. The system 110 aids a requestor 122 to arrange a communication session with a target 121 via an authorizer 123. A requestor 122 may search 125 for a target 121. Depending upon the setting of the target the system may or may not provide the targets details. A virtual assistant/authoriser 131 or an authorizer 123 may at that stage prevent the targets 121 information being provided to the requestor 122.

Once the requestor 122 has the target's 121 information the requestor 122 can request 126 a communication session. Again, a virtual assistant/authoriser 131 or an authorizer 123 can process the request and if the request is acceptable will schedule the communication session. Both the requestor's 122 and target's 121 schedule 141, 142 can be taken into account by the authoriser 123 or virtual assistant/authoriser 131.

Once the time window 150 is agreed the requestor 122 can initiate 155 the communication session, the system 110 checks that the communication session is authorised and connects 156 the requestor 122 to the target 121.

The system 110 analyses 160 the session and make the information available to the authoriser 123.

While it is envisaged most the communication sessions may be one off, the system and method provides for the control of time-based communication sessions. For example the requesting party may be granted access anytime, once only at a specific time, business days between 8 am and 6 pm. An example could be a romantic partner is allowed access anytime, but because the communication session goes through the system and method of the present invention should the parties separate then the target party 121 can remove the authorization. This potentially saves the target party 121 from having to change their phone number.

The system has been created to address the needs of those people that have high public profiles and provides the ability to communicate with a caller on an agreed basis, either one time or ongoing all while not revealing their private communication details.

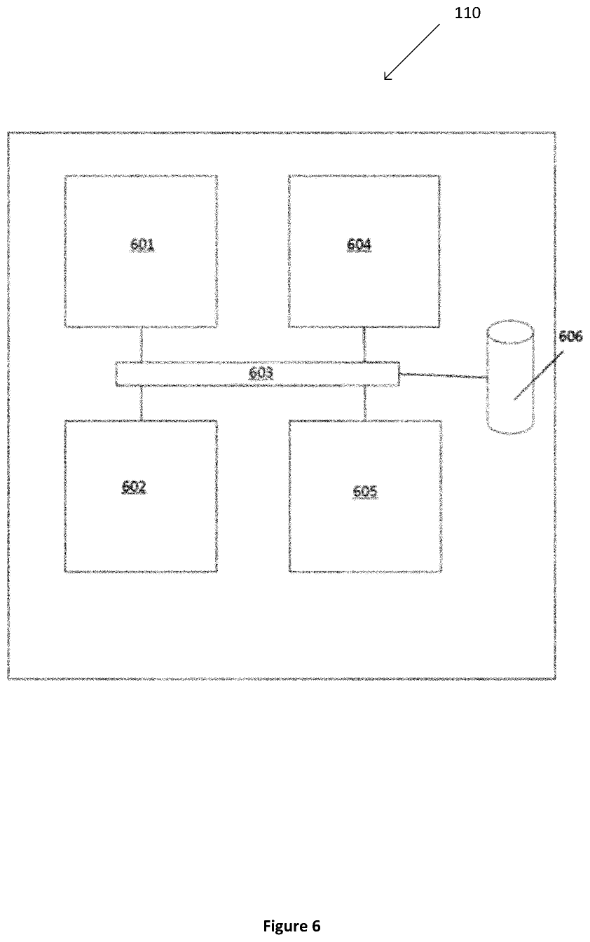

Referring to FIG. 6, the system is operated by a system controller 110. The system controller 110 includes at least one processor 601, one or more memory devices 602 or an interface for connection to one or more memory devices, input and output interfaces for connection to external devices in order to enable the system to receive and operate upon instructions from one or more users or external systems, a data bus 603 for internal and external communications between the various components, and a suitable power supply 605. Multiple system controllers 110 may be used. Further, the system controller 110 includes one or more communication devices 604 (wired or wireless) for communicating with external and internal devices, the communication devices enables the system controller to control telephone and video communications. The system controller 110 further includes one or more input/output devices, such as a display, pointing device, keyboard or printing device and one or more data storage devices such as hard drives 606.

The processor of the system controller 110 is arranged to perform the steps of a program stored as program instructions within the memory device. The program instructions enable the various methods of performing the invention as described herein to be performed.

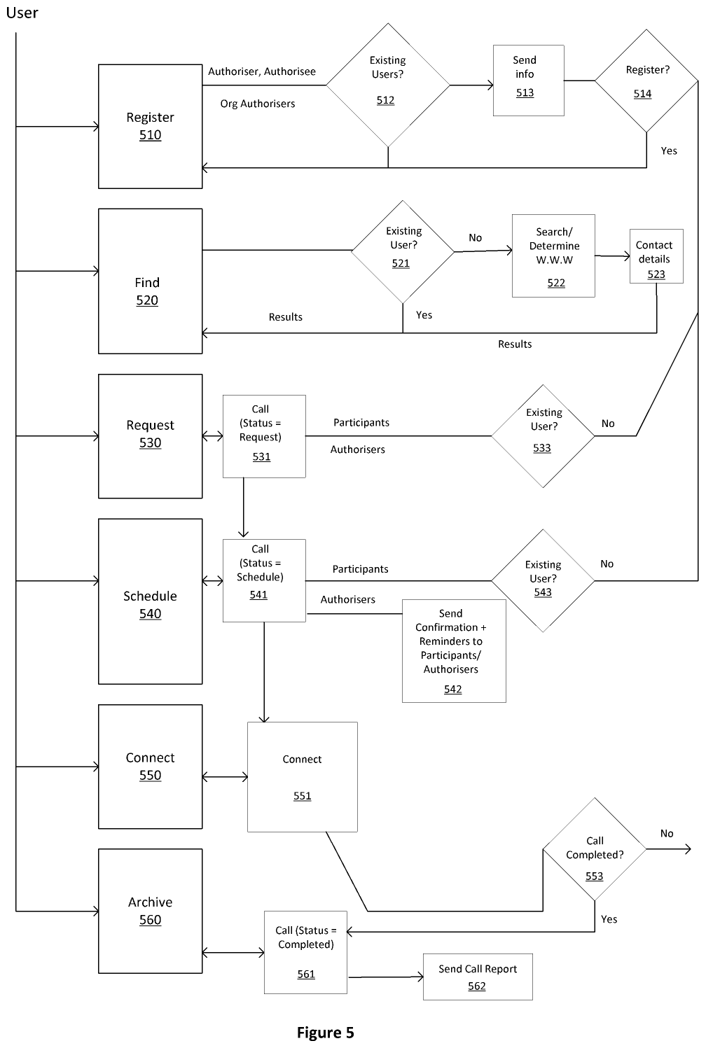

Referring to FIG. 5 the information and communication flow of an exemplary embodiment is illustrated. A user registers 510 their details with the system 110. While described as being registered by the user, in a least one embodiment another user such as an agent may register user details. The details stored by the system 110 can include but are not limited to the users name, whether the user is a registered user, biographical information, contact details, a list of registered devices, the organisations (if any) the user is associated with, a list of other users who may authorise communications sessions on behalf of the user (if any), a list of other users who have authorised this user to authorise communications sessions on their behalf, the user usual location and the users usual time zone

The contact details of a user may include their mobile phone number (for calls and SMS), other telephone numbers, email addresses and social handles. Registered devices in the system are identified by their MAC Address—“a unique identifier assigned to network interfaces for communications”. This allows registered devices to communicate without the use of phone numbers.

A user may add other users. For example, an authoriser may become an authoriser for existing users 512 by asking 513 the user or the users authoriser to authorise them, if the user or authoriser accepts the authoriser then the authoriser becomes an authoriser for the user. Alternative an authoriser may send information 513 to new user, who may or may not decide to register 514. Requesting and target users who are not registered may still have a communication session set up by an authoriser.

Referring again to FIG. 5, the system also provides the ability for a user and in particular, a target user to be found by providing a finder application 520. To find a user a search is conducted, if the searched user is an existing user 521 the results will be provided. Except of course where a user has requested them to be kept confidential. If the searched user is not an existing user the system may search using other databases 522 to extract the searched users contact details 223.

Once the searched user has been found or the caller is provided with the details in another way, such as being provided with the targets details a request 530 for a call 531 can be made and has an initial status of requested 531. The details of the call are discussed below. A call is managed and negotiated by an authoriser and a requester. If the target of the call is an existing user then it may be as simple as the authoriser accepting the request, this may happen immediately. Alternatively, if the request is for a user not on the system and possibly not having an authoriser the system may send request information to the target 121. If the target 121 then registers with the system or is registered by another user the request can be accepted.

A communication session may be scheduled 540 and has an initial status of unscheduled, once scheduled has a status 541 of scheduled. A system user, or their authoriser may schedule a communication session, once the requester and authoriser agree the call is scheduled or authorised 541. In some situations, the schedule may not be acceptable to either party and may be renegotiated. In some cases, the call may be connected 551 immediately. Optionally the system may remind the parties (authorisers, requestor and targets 121) of the upcoming scheduled 542 communication session. Connect 551 immediately may be implemented by scheduled 541 immediately leading to connect 551, and simply bypassing the need for notifications/reminders 542.

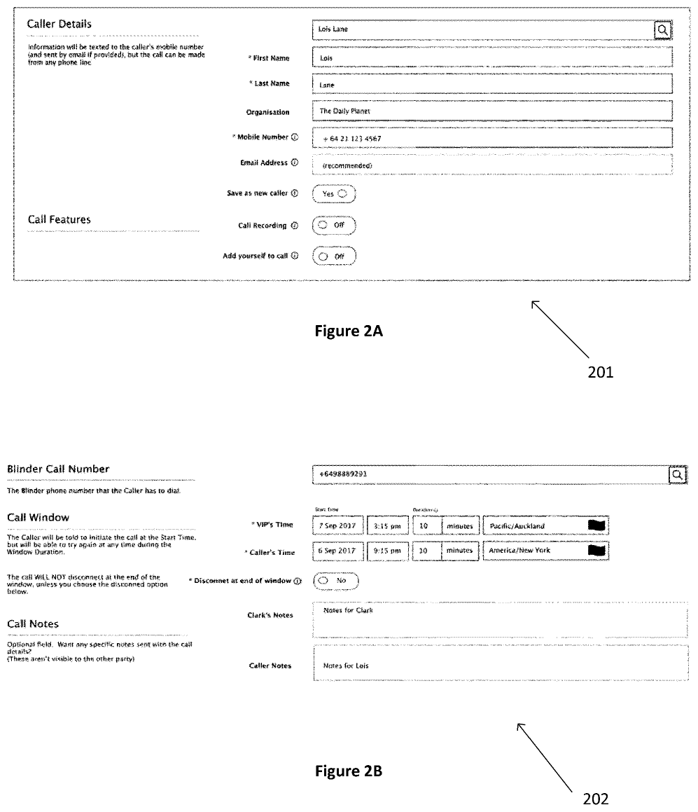

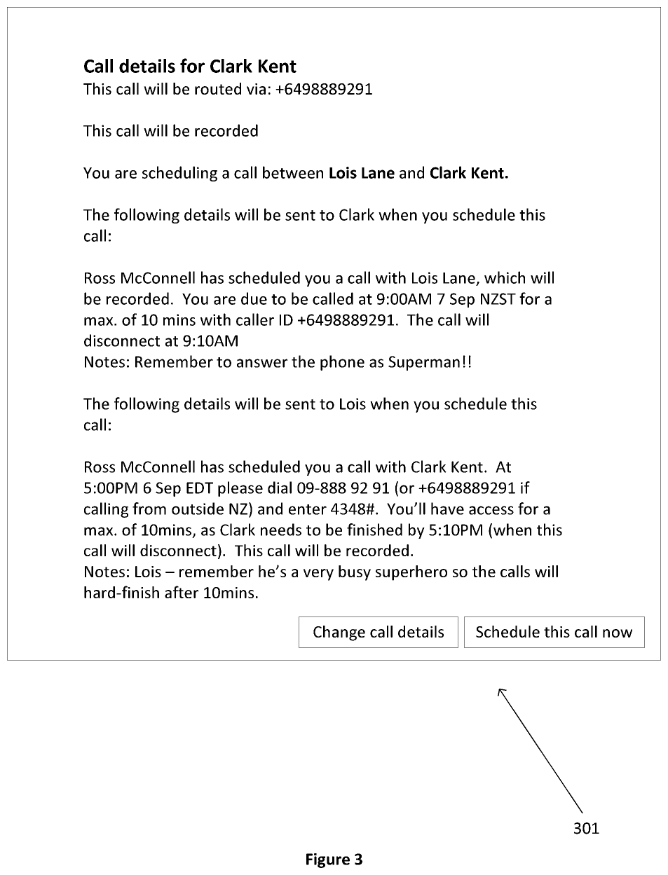

The interface for scheduling the communication sessions can be seen in FIGS. 2A, 2B and 3. FIGS. 2A and 2B, 201, 202 show the details that can be entered by the authoriser. FIG. 3 shows a confirmation of schedule screen 301.

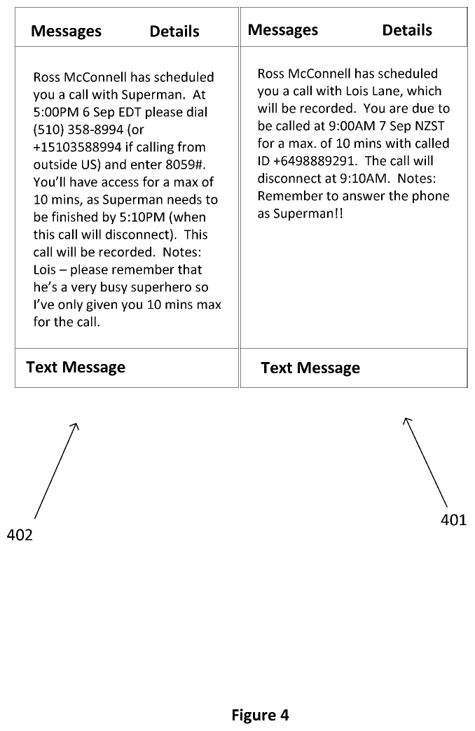

Once the communication session is scheduled 541 a confirmation 542 may be sent, for example the txt messages 401, 402 to the requester and the target 121 as seen in FIG. 4.

When the communication session is connected 550 the status 551 changes to connected 551. After the communication session is completed 553, the system may archive 560 the details update the status of the communication session to completed and may send a communication session report 562. Optionally the communication session may be recorded, this is usually decided during scheduling and the parties will be notified. Alternatively, the decision on whether or not to record a communication session may be made by the authoriser depending on factors such as the source of the communication session.

In some embodiments a request for a communication session may be a request to negotiate for a communication session.

In other embodiments, a system-enabled virtual assistant/authoriser may act as an authorizer for a user, e.g. in cases where a target user 121 does not want to self-authorise or does not have an authoriser such as a manager.

In one embodiment the virtual assistant/authoriser could have access to the multiple data sources and applys machine learning to assist with connection and scheduling decisions for communication sessions. The data sources may include:
The targets 121 mobile phone call logs, contacts, and calendar;
The targets 121 specific instructions as they relate to recognised callers (e.g. my wife can call me anytime, my colleague can call me during work hours and override out of hours in emergencies, a one-off meeting can call me once at the agreed time, for a doctor—my patient can call me anytime during specific hours during the next 2 weeks while they recover);
Third party information that is available on the web about the call activity and owners of certain phone numbers that may be trying to connect with the target 121—e.g. numbers that are being used by call centres and making hundreds of dials a day, and therefore not likely to be of interest to the target;
Information that a target 121 may share with the virtual assistant/authoriser via “chat” when an incoming call has been intercepted (e.g. virtual assistant/authoriser: “Hi Boss, I have a call from <caller name>, they say it's urgent, can you talk now or would you prefer I take a message?”. The target 121 is provided with some default options like “Talk Now”, “Take message”, “Schedule as soon as I'm free”);
The complete archive of instructions that the target 121 has ever provided to the virtual assistant/authoriser;
The time zone the target 151 is located in so that the target 151 is not disturbed in the middle of the night; and
An override passcode such as a word for example “I need fish and chips” or a code to be entered such as a number “12345678”.

In another embodiment it is envisaged that the virtual assistant/authoriser would use a neural network to assist in deciding whether or not to connect a call, reject a call or schedule the call for later.

It is further envisaged that instead of having a contact list on a mobile device a system user would store their contacts on the system and would use the system to place all calls. The mobile device would be authorised to access the contact using the unique ID (IMEI, MEID, or ESN) the device. In a similar manner, the system could be used as a plug in for applications to secure contact details.

Each user may be associated with multiple organisation(s) and the organisation(s) may authorise one of more authorisers. The authoriser(s) are users who are authorised by another user (the authorisee) or authorised by an organisation(s) to act as an authoriser for users associated with the organisation.

An authoriser will usually have more than one authorisees. For example, one or more media liaison officers for a sport team may be an authoriser for the team's players, coaches and management.

Authorisee(s) are users who has given authority to another user to manage their calls. A user may assign authoriser status to more than one other user and this will often be done on an organisation basis. A single user can be a target, an authoriser and an authorisee.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A method of establishing a communication session between at least two parties comprising the steps of:
receiving information from a plurality of parties, the information on the parties comprising:
at least one associated party type, the party type selected for the group comprising targets, authorisers and requestors, and
at least one communication method;
storing the information;
receiving a request to store information on an authoriser, the information on the authoriser including:
information on the contacts with a target party the authoriser may authorise,
information on whether the authoriser may authorise other parties as authorisers, and
the period the authoriser is authorised for;
storing the information on the authoriser;
receiving a request from a requesting party to contact a target party;
communicating the request to contact a target party to an authoriser associated with the target party;
facilitating an agreement between the requesting party and the authoriser;
receiving a schedule for at least one time period that the requesting party is authorised to contact the target party from the authoriser;
notifying the requesting party of the at least one time period; and
establishing a communication session between the requesting party and the target party if the requesting party is authorised to contact the target party at the time the communication session is initiated.

2. The method of claim 1 wherein the authorisers are authorised representatives of a target.

3. The method of claim 1 or claim 2 wherein the authoriser and the target party are the same party.

4. The method of any one of claims 1 to 3 including the step of receiving from each party information on a plurality of communication channels.

5. The method of claim 4 wherein the communication channels are kept confidential and the step of establishing a communication session between the requesting party and the target party includes establishing a confidential communication session between the requesting party and the target party.

6. The method of any one of the previous claims including the step of notifying the target party of the communication session including notifying the target party of the time period.

7. The method of claim 6 including the step of notifying the parties of the communication session.

8. The method of any one of the previous claims including the step of providing a search tool to search the stored information on the parties and wherein the method incudes receiving a request to search for a target party and providing a list of target parties that match the search criteria.

9. The method of claim 8 including the step of receiving a request to exclude a target party for a search and wherein a target party that is excluded from a search is not provided in the list of target parties.

10. The method of any one of the previous claims wherein the communication session is established over a channel selected from the group comprising a web application, a mobile telephone, a telephone line.

11. The method of any one of the previous claims wherein the steps of notifying the requesting party of the at least one time period occurs by connecting the requesting party.

12. The method of claim 11 wherein establishing a communication session between the requesting party and the target party if the requesting party is authorised to contact the target party at the time the communication session is initiated occurs immediately.

13. The method of any one of the previous claims wherein the authoriser is a virtual authoriser.

14. The method of claim 13 wherein the virtual authoriser accesses multiple data sources and applies machine learning to assist with connection and scheduling decisions.

15. The method of claim 13 or claim 14 wherein the virtual authoriser uses neural networks to assist with connection and scheduling decisions.

16. A computer programmed or operable to implement the method of any one of the proceeding claims.

17. One or more computer readable media storing computer-usable instructions that, when used by a computing device, causes the computing device to implement the method of any one of claims 1 to 15.

18. A system for controlling communication session between at least two parties,
the system comprising:
one or more processors;
memory in communication with the one or more processors;
a plurality of communication devices;
wherein the one or more processors are programmed to:
receiving information from a plurality of parties, the information on the parties comprising:
at least one associated party type, the party type selected for the group comprising targets, authorisers and requestors, and
at least one communication method;
storing the information in memory;
receiving a request to store information on an authoriser, the information on the authoriser including:
information on the contacts with a target party the authoriser may authorise,
information on whether the authoriser may authorise other parties as authorisers, and
the period the authoriser is authorised for;
storing the information on the authoriser in memory;
receiving a request from a requesting party to contact a target party;
communicating the request to contact a target party to an authoriser associated with the target party;
facilitating an agreement between the requesting party and the authoriser;
receiving a schedule for at least one time period that the requesting party is authorised to contact the target party from the authoriser;
notifying the requesting party of the at least one time period; and
establishing a communication session between the requesting party and the target party using the communication devices only if the requesting party is authorised to contact the target party at the time the communication session is initiated.

19. The system of claim 18 wherein the authorisers are authorised representatives of a target party.

20. The system of claim 18 or claim 19 wherein the authoriser and the target party are the same party.

21. The system of any one of claims 18 to 20 wherein the one or more processors are further programmed to receive from each party information on a plurality of communication channels.

22. The system of claim 21 wherein the communication channels are kept confidential and establishing a communication session between the requesting party and the target party includes establishing a confidential communication session between the requesting party and the target party.

23. The system of any one of claims 18 to 22 wherein the one or more processors are further programmed to notify the target party of the communication session including notifying the target party of the time period.

24. The system of claim 23 wherein the one or more processors are further programmed to notify the parties of the communication session.

25. The system of any one of claims 18 to 24 wherein the one or more processors are further programmed to provide a search tool to search the stored information on the parties and wherein the one or more processors are further programmed to receive a request to search for a target party and provide a list of target parties that match the search criteria.

26. The system of claim 25 wherein the one or more processors are further programmed to receive a request to exclude a target party for a search and wherein a target party that is excluded from a search is not provided in the list of target parties.

27. The system of any one of claims 18 to 26 wherein the communication session is established over a channel selected from the group comprising a web application, a mobile telephone, a telephone line.

28. The system of any one of claims 18 to 27 wherein the steps of notifying the requesting party of the at least one time period occurs by connecting the requesting party.

29. The system of claim 28 wherein establishing a communication session between the requesting party and the target party if the requesting party is authorised to contact the target party at the time the communication session is initiated occurs immediately.

30. The system of any one of claims 18 to 29 wherein the authoriser is a virtual authoriser.

31. The system of claim 30 wherein the virtual authoriser accesses multiple data sources and applies machine learning to assist with connection and scheduling decisions.

32. The system of claim 30 or claim 31 wherein the virtual authoriser uses neural networks to assist with connection and scheduling decisions.
